(19) United States
(12) Patent Application Publication
(10) Pub. No.: US 2016/0148484 A1
(43) Pub. Date: May 26, 2016

(54) WARNING SYSTEM FOR USE IN DAILY LIFE

(71) Applicant: ROHM CO., LTD., Kyoto (JP)

(72) Inventors: Soichiro ARIMURA, Kyoto (JP); Masahide TANAKA, Osaka (JP)

(21) Appl. No.: 14/906,031

(22) PCT Filed: Jul. 18, 2014
(86) PCT No.: PCT/JP2014/069173

§ 371 Date: Jan. 19, 2016

(30) Foreign Application Priority Data
Jul. 22, 2013 (JP) 2013-152110
Jul. 16, 2014 (JP) 2014-145654

(51) Int. Cl. G08B 21/18; F24F 11/00

(52) U.S. Cl. CPC G08B 21/182; F24F 11/0034

(57) ABSTRACT

Provided is a warning system that makes it possible to decrease the possibility of the occurrence of heat shock that is caused by a difference in temperature between a living room and a dressing room when a person who is about to enter a bath removes their clothing. The warning system comprises: a living room temperature sensor (28) that measures the temperature in a living room (4); a dressing room temperature sensor (54) that measures the temperature in a dressing room (8); and a warning unit (50) that issues a warning when the temperature difference between the temperature of the living room (4) and the temperature of the dressing room (8) is equal to or greater than a predetermined value.

### TECHNICAL FIELD

The present invention relates to a warning system for use in daily life.

### BACKGROUND ART

Various types of dangers lurk in daily life. As one example, there has been pointed out a danger that, in a winter season, a person trying to take a bath might experience a heat shock while getting undressed due to a temperature difference between a living room and a dressing room, and various types of measures have been taken to prevent this. For example, in order to suppress occurrence of a heat shock in a person who has moved from a living room to a dressing room, it has been proposed to provide an air supply mechanism that supplies air in the living room to the dressing room (Patent Document 1). Meanwhile, it has been proposed to generate, based on a temperature of a dressing room or a temperature difference between the dressing room and a room adjacent thereto, a scent or a sound that suppresses a blood pressure rise or light that increases a body's sensory temperature (Patent Document 2).

### LIST OF CITATIONS

### Patent Literature

### Patent Document 1: JP-A-2009-216367

### Patent Document 2: JP-A-2012-032066

### SUMMARY OF THE INVENTION

### Technical Problem

With regard to more useful measures to prevent dangers in daily life, however, many challenges exist to which further consideration should be given.

In view of the above, it is an object of the present invention to propose a warning system that is useful in daily life.

### Solution to the Problem

A warning system disclosed herein is configured to have a living room temperature sensor that measures a room temperature of a living room, a dressing room temperature sensor that measures a room temperature of a dressing room, and a warning portion that gives a warning to a subject person when a difference between the room temperature of the living room and the room temperature of the dressing room is not less than a predetermined value (first configuration).

Preferably, the warning system of the first configuration is configured to have an air heating portion that is provided in the dressing room and a control portion that, based on the living room temperature sensor and the dressing room temperature sensor, controls the air heating portion to function when the difference between the room temperature of the living room and the room temperature of the dressing room is not less than a predetermined value (second configuration). Furthermore, preferably, the warning system of the first configuration is configured so that a human presence sensor is provided, and based on the human presence sensor, the warning portion gives the warning (third configuration).

Furthermore, preferably, the warning system of the first configuration is configured to have a judgement portion that judges whether the subject person has accepted or disregarded the warning by the warning portion and an accumulation portion that records a result of the judgement by the judgement portion and accumulates a behavior history of the subject person (fourth configuration). Furthermore, preferably, the warning system of the fourth configuration is configured to have a communication portion that communicates to an exterior the result of the judgement by the judgement portion (fifth configuration).

Furthermore, preferably, the warning system of the first configuration is configured so that the warning by the warning portion includes a preliminary warning for creating a warning accepting mentality and a full-fledged warning including warning content information (sixth configuration). Furthermore, preferably, the warning system of the first configuration is configured to have a testing unit that tests a function of the warning portion in any other season than a season in which the warning by the warning portion is required (seventh configuration).

Furthermore, a warning system disclosed herein is configured to have a living room temperature sensor that measures a room temperature of a living room, a dressing room temperature sensor that measures a room temperature of a dressing room, a warning portion that, based on an air temperature difference between the living room temperature sensor and the dressing room temperature sensor, gives a warning to a subject person, an accumulation portion that accumulates a behavior history as to whether the subject person has accepted or disregarded the warning by the warning portion, and an analysis portion that analyzes the behavior history accumulated in the accumulation portion (eighth configuration).

Preferably, the warning system of the eighth configuration is configured so that, based on the behavior history, the analysis portion categorizes the subject person under one of a plurality of categories defined in terms of a risk (ninth configuration). Furthermore, preferably, the warning system of the ninth configuration is configured so that, based on the result of categorizing, the warning portion changes a content of the warning to the subject person (tenth configuration).

Furthermore, preferably, the warning system of the ninth configuration is configured so that a communication portion that communicates to an exterior is provided, and based on the result of categorizing, the communication portion decides whether or not to transmit information from the analysis portion to the exterior (eleventh configuration). Furthermore, preferably, the warning system of the eleventh configuration is configured so that, based on the result of categorizing, the communication portion changes a content of communication of the information to be communicated to the exterior (twelfth configuration). Furthermore, preferably, the warning system of the eleventh configuration is configured so that, based on the result of categorizing, the communication portion changes a communication destination to which the information from the analysis portion is to be communicated (thirteenth configuration).

Furthermore, preferably, the warning system of the eighth configuration is configured so that an information acquisition portion is provided that acquires information related to an air temperature change, and based on the information acquisition portion, the warning portion controls the warning (fourteenth configuration). Furthermore, preferably, the warning system of the fourteenth configuration is configured so that the information related to an air temperature change is at least one of a date and an air temperature forecast (fifteenth configuration).

Furthermore, a warning system disclosed herein is configured to have a living room temperature sensor that measures a room temperature of a living room, a dressing room temperature sensor that measures a room temperature of a dressing room, a warning portion that, based on a temperature difference between the living room temperature sensor and the dressing room temperature sensor, gives a warning to a subject person, and a testing portion that tests a function of the warning portion in any other season than a season in which the warning by the warning portion is required (sixteenth configuration).

Preferably, the warning system of the sixteenth configuration is configured so that in the season in which the warning by the warning portion is required, based on the temperature difference between the living room temperature sensor and the dressing room temperature sensor, the warning portion gives the warning, and in any other season than the season in which the warning by the warning portion is required, based on occurrence of a phenomenon of a reversed temperature difference between the living room temperature sensor and the dressing room temperature sensor, the testing portion tests a function of each of the living room temperature sensor and the dressing room temperature sensor (seventeenth configuration). Furthermore, preferably, the warning system of the sixteenth configuration is configured so that the warning portion has a human presence sensor that is provided in the dressing room, and in any other season than the season in which the warning by the warning portion is required, based on whether or not the human presence sensor detects human presence within a predetermined period of time while the subject person is at home, the testing portion tests a function of the human presence sensor (eighteenth configuration).

Furthermore, preferably, the warning system of the sixteenth configuration is configured so that the warning portion has a warning output portion that is provided in the dressing room, and in any other season than the season in which the warning by the warning portion is required, by applying power to the warning output portion, the testing portion tests a function of the warning output portion (nineteenth configuration). Furthermore, preferably, the warning system of the sixteenth configuration is configured so that at an early stage upon arrival of the season in which the warning by the warning portion is required, the warning portion calls attention to the warning (twentieth configuration).

### Advantageous Effects of the Invention

As described above, according to the present invention, there is provided a warning system that is useful in daily life.

### BRIEF DESCRIPTION OF DRAWINGS

FIG. 1 is a system diagram showing an overall configuration of Example 1 of the present invention (Example 1).

FIG. 2 is a basic flow chart showing an operation of a controller in Example 1 shown FIG. 1.

FIG. 3 is a flow chart showing a detail of Step S14 in FIG. 2.

FIG. 4 is a flow chart showing a detail of Step S18 in FIG. 2.

FIG. 5 is a flow chart showing a detail of Step S22 in FIG. 2.

FIG. 6 is a flow chart showing a detail of Step S24 in FIG. 2.

FIG. 7 is a flow chart showing a detail of Step S26 in FIG. 2.

FIG. 8 is a flow chart showing a detail of Step S28 in FIG. 2.

FIG. 9 is a flow chart showing a detail of Step S30 in FIG. 2.

### DESCRIPTION OF EMBODIMENTS

### Example 1

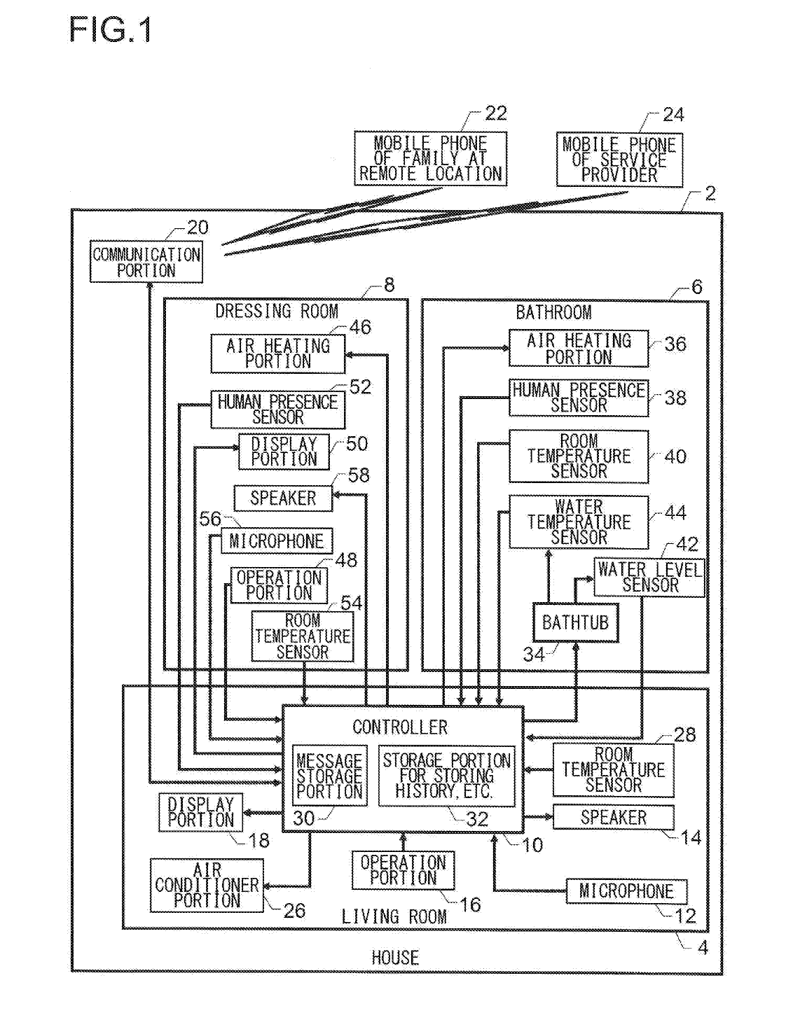

FIG. 1 is a block diagram showing an overall configuration of Example 1 according to an embodiment of the present invention. Example 1 is constituted by a warning system at a dressing room of a bath in a household. A house 2 has a living room 4, a bathroom 6, and a dressing room 8 adjacent to the bathroom 6. In some cases, the living room 4 and the dressing room 8 are adjacent to each other, and in other cases, they are connected to each other via a corridor. In either case, in a winter season, due to a temperature difference between the living room 4 and the dressing room 8, there is a danger that a resident who has moved from the living room 4 to the dressing room 8 might experience a heat shock while getting undressed. As measures to take to prevent this, Example 1 is intended, first, to reduce a temperature difference between the living room 4 and the dressing room 8 and, secondly, to keep the resident from getting undressed in the dressing room 8 in which such a temperature difference remains uncorrected.

A controller 10 of the living room 4 performs control of the entire system and is provided with a telephone function that enables, by using a microphone 12, a speaker 14, an operation portion 16, a display portion 18, and a communication portion 20, communication with a mobile phone 22 of a family at a remote location, a mobile phone 24 of a watch service provider, or the like. The controller 10 can also perform, based on a manual operation and setting using the operation portion 16 and the display portion 18, manual control of air heating by an air conditioner portion 26 that is capable of air cooling and heating and, based on a room temperature sensor 28 and so on, automatic control of air heating by the air conditioner portion 26. Moreover, the controller 10 has a message storage portion 30 that stores audio data for an after-mentioned heat shock warning or the like and a storage portion 32 for storing a history, etc. that stores, for example, a history of a resident's behavior with respect to a warning. Although, for convenience in explaining a function, these storage portions are depicted as separate portions, in practice, respective functions of these storage portions are realized as a control program of the controller 10 and functions of a ROM or a RAM for storing necessary data. The storage portion 32 for storing a history, etc. also performs, for example, recording of a result of measuring a room temperature by the room temperature sensors 28, 40, and 54.

Based on a manual operation and setting using the operation portion 16 and the display portion 18 of the living room 4, hot water filling, reheating, and so on of a bathtub of the bathroom 6 are manually or automatically controlled by the controller 10 of the living room 4. Furthermore, based on a manual operation and setting using the operation portion 16 and the display portion 18 of the living room 4, an air heating portion 36 of the bathroom 6 is manually controlled by the controller 10 of the living room 4. Moreover, as will be described later, based on various situations related to the dressing room 8 as well as a human presence sensor 38, the room temperature sensor 40, and a water level sensor 42 and a water temperature sensor 44 that belong to a bathtub 34 in the bathroom 6, the air heating portion 36 is automatically controlled by the controller 10.

Based on a manual operation and setting using the operation portion 16 and the display portion 18 of the living room 4, an air heating portion 46 of the dressing room 8 is manually controlled by the controller 10 of the living room 4. A configuration also can be adopted in which, based on a manual operation using an operation portion 48 and a display portion 50 in the dressing room 8, the air heating portion 46 of the dressing room 8 is manually controlled by the controller 10 of the living room 4. Moreover, as will be described later, based on various situations related to the bathroom 6 as well as a human detection sensor 52 and the room temperature sensor 54 in the dressing room 8, the air heating portion 46 is automatically controlled by the controller 10.

Basically, the automatic control of air heating by the air heating portion 46 in the dressing room 8 and the air heating portion 36 in the bathroom 6 is performed for the purposes of preventing, by using the room temperature sensor 28 in the living room 4 and the room temperature sensor 54 in the dressing room 8, a temperature in the dressing room 8 from decreasing to a low temperature not higher than a predetermined value, a temperature difference between the living room 4 and the dressing room 8 from increasing to a value not less than a predetermined value, and useless air heating from being performed in the dressing area 8 and the bathroom 6. This will be detailed later.

Also at the dressing room 8, there are provided a microphone 56 and a speaker 58 that are connected to the controller 10, and thus also from the dressing room 8, through an operation based on the operation portion 48 and the display portion 50, by the communication portion 20, it is possible to communicate with the mobile phone 22 of the family at a remote location, the mobile phone 24 of the watch service provider, or the like. Furthermore, when it is detected by the room temperature sensor 28 and the room temperature sensor 54 that a temperature in the dressing room 8 is low with a value not higher than the predetermined value or that a temperature difference between the living room 4 and the dressing room 8 is not less than the predetermined value, the controller 10 performs control so that, from the speaker 58, an audio message giving a warning to refrain from getting undressed is outputted. This is a voice message stored beforehand in the message storage portion 30 and includes a hello message by voice from the family at a remote location recorded during a telephone conversation such as a message “Have you been well, Mother?” and a message indicating a content of the warning prepared beforehand on a system side. Further, by outputting first the hello message followed by the message indicating the content of the warning, contrivance is effected to create a psychological situation in which the resident of the house 2 such as a solitary aged person accepts the warning, instead of disregarding it, and dissuades himself/herself from getting undressed.

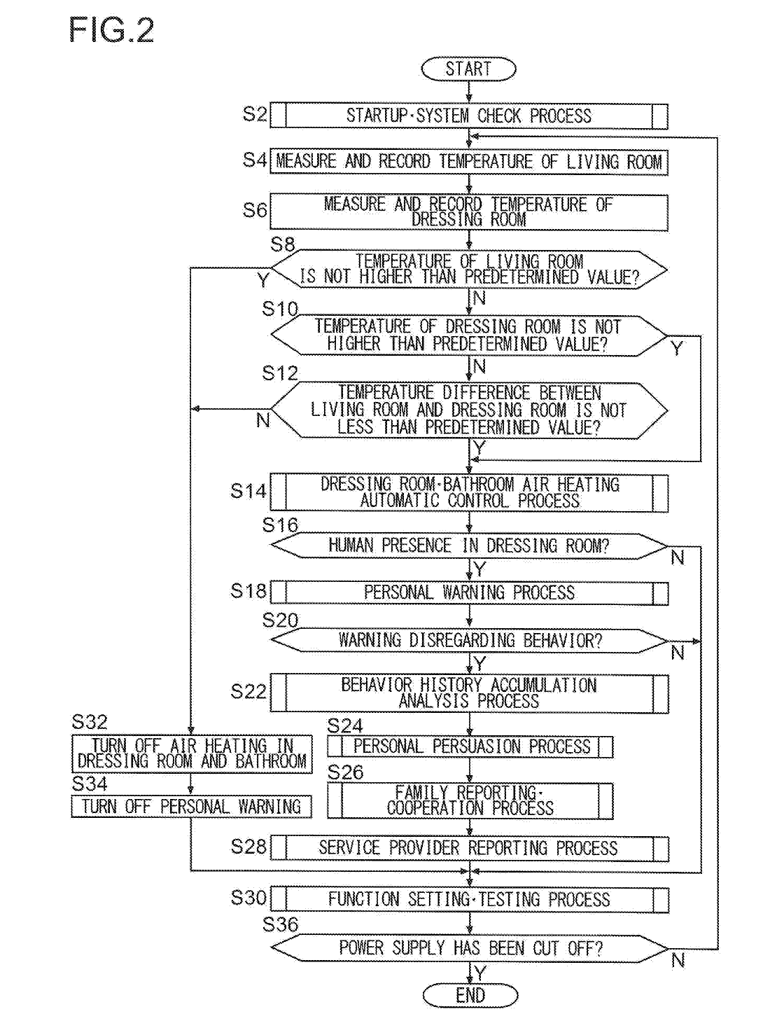

FIG. 2 is a basic flow chart explaining an operation of the controller 10 in Example 1. A flow starts upon the start of power supply to the system, and at Step S2, a startup process and a system check process of the system are performed, after which a transition is made to Step S4. At Step S4, a temperature of the living room 4 is measured by the room temperature sensor 28, and a result of the measurement is recorded in the storage portion 32 for storing a history, etc. of the controller 10. Moreover, at Step S6, a temperature of the dressing room 8 is measured by the room temperature sensor 54, and a result of the measurement is recorded in the storage portion 32 for storing a history, etc., after which a transition is made to Step S8.

At Step S8, based on the result of the measurement obtained this time, it is checked whether or not a room temperature of the living room 4 is not higher than a predetermined value. This is performed for the following purpose. That is, when the room temperature of the living room 4 is not higher than the predetermined value, it is conceived that air heating by the air conditioner portion 26 is not being performed and thus that the resident is not using the living room 4, and in such a case, the resident is released from supervision in preventing occurrence of a heat shock. When, at Step S8, it is found that the living room temperature does not have a value not higher than the predetermined value, an advance is made to Step S10 at which it is checked whether or not a room temperature of the dressing room 8 is not higher than a predetermined value. This is performed for the purpose of detecting a situation in which a difference between the room temperature in the dressing room 8 and a body temperature is great and thus the resident is in a dangerous state regardless of the room temperature of the living room 4. When, at Step S10, it is found that the dressing room temperature does not have a value not higher than the predetermined value, an advance is made to Step S12 at which it is checked whether or not a difference between the room temperature of the living room 4 and the room temperature of the dressing room 8 is not less than a predetermined value. This is performed for the purpose of detecting a situation in which, even when the room temperature in the dressing room 8 is not lower than the predetermined Value, a room temperature difference between the living room 4 and the dressing room 8 is great and thus there is a danger of occurrence of a heat shock. Then, when the room temperature difference is not less than the predetermined value, a transition is made to Step S14. When, at Step S10, it is found that the dressing room temperature is not higher than the predetermined value, a transition is made directly to Step S14.

At Step S14, based on a result of the detection, a process of automatically controlling the air heating portion 46 of the dressing room 8 and the air heating portion 36 of the bathroom 6 is performed. This process corresponds mainly to a process of automatically turning on the air heating portion 46 and the air heating portion 36 and also includes a process, of automatically turning off the air heating portion 46 and the air heating portion 36 so that useless air heating is not performed. This will be detailed later. Upon completion of such a dressing room bathroom air heating automatic control process at Step S14, a transition is made to Step S16.

At Step S16, it is checked by the human presence sensor 52 whether or not the resident has entered the dressing room 8. When such entry is detected, a transition is made to a personal warning process at Step S18. This is basically a process of giving a warning, in the form of an audio message from the speaker 58, blinking of the display portion 50, and so on, to the resident himself/herself not to get undressed and also includes a process of preventing an unnecessary warning and a process of recording how the resident has reacted to the warning. This will be detailed later. Upon completion of the personal warning process at Step S18, a transition is made to Step S20.

At Step S20, it is checked whether or not a history of a warning disregarding behavior of the resident, such as getting undressed despite the warning at Step S18, has been recorded. Then, when any corresponding record is found, an advance is made to Step S22 at which a behavior history exhibited this time is, recorded and accumulated and a process of analyzing the record thus accumulated is performed, after which a transition is made to Step S24. Step 24 is a process of outputting a message persuading the resident himself/herself that there is a danger of occurrence of a heat shock and that he/she has repeatedly disobeyed the warning. The message to be outputted in this process includes not only an in-situ message output from the speaker 58 but also a message output from the speaker 14 at the living room 4. Step S22 to Step S24 will be detailed later.

Upon completion of such a personal persuasion process at Step S24, an advance is made to Step S26 at which a process of preventing a dangerous behavior by reporting to and by cooperation with the family is begun. This process includes automatically reporting the dangerous behavior, by the communication portion 20, from the system to the mobile phone 22 of the family at a remote location, and performing, based thereon, a persuasion back-up process through a telephone conversation via the mobile phone 22 of the family at a remote location and the microphone 12 and the speaker 14 in the living room 4. This will be detailed later.

Upon completion of such a family reporting • cooperation process at Step S26, an advance is made to Step S28 at which a process of preventing the dangerous behavior by reporting to the mobile phone 24 of the watch service provider is begun. This process includes automatically reporting the dangerous behavior, by the communication portion 20, from the system to the mobile phone 22 of the watch service provider, performing, based thereon, a persuasion back-up process through a telephone conversation via the mobile phone 24 of the watch service provider and the microphone 12 and the speaker 14 in the living room 4, and further performing an on-site service automatic request process of automatically requesting an on-site service at the house 2 from the system to the watch service provider. This will be detailed later.

Upon completion of such a service provider reporting process at Step S28, a transition is made to Step S30. In a case where, at Step S16, human presence in the dressing room 8 is not detected, a transition is made directly to Step S30. Moreover, also when, at Step S20, the resident obeys the warning and there is no record of his/her disregarding it, a transition is made directly to Step S30. Step S28 and Step S30 will be detailed later. On the other hand, in a case where, at Step S8, it is detected that the room temperature of the living room 4 is not higher than the predetermined value, a transition is made to Step S32. Similarly, also when, at Step S12, it is not detected that a difference between the room temperature of the living room 4 and the room temperature of the dressing room 8 is not less than the predetermined value, a transition is made to Step S32.

At Step 32, the air heating portion 46 of the dressing room 8 and the air heating portion 36 of the bathroom 6 are automatically turned off, after which a transition is made to Step S34. In a case where the air heating portions 46 and 36 had originally been turned off, no action is made at Step S32, and a transition is made to Step S34. At Step S34, a personal warning function is turned off, after which a transition is made to Step S30. In a case where, when Step S34 is reached, the function related to a personal warning is not operating, no action is made at Step S34, and a transition is made to Step S30.

At Step S30, a function setting and testing process is performed. This is a process of making various settings for operation conditions and changes thereto by the operation portion 16 and the display portion 18. This also includes, for example, setting of an air heating turning-on time on a timer. Step S30 also includes a process of performing testing on the system. Since the example of the present invention is to provide measures to prevent occurrence of a heat shock in a winter season, the portions that perform Step S14 to Step S28 do not function for a long period of time including a summer season. It is, therefore, of significance to check on a routine basis whether or not the system would function properly when a next winter season comes around. In the example of the present invention, the system is configured so that, regardless of whether or not the automatic control of air heating and a warning function operate, Step S30 is reached, and so that a normal telephone conversation function with respect to the mobile phone 22 of the family at a remote location via the microphone 12 and the speaker 14 is interlocked with a testing function, and at the time of operating the normal telephone conversation function, it is checked whether or not the various sensors and Step S4 to Step S34 function properly. By this configuration, it is guaranteed that, as long as a normal telephone conversation can be made, Step S14 to Step S28 function properly.

Upon completion of the function setting • testing process at Step S30, the flow reaches Step S36 at which it is checked whether or not power supply to the system has been cut off. Then, unless the power supply has been cut off, Step S4 to Step S36 are repeatedly performed. On the other hand, when, at Step S36, it is detected that the power supply has been cut off, a necessary shutoff process is performed to end the flow.

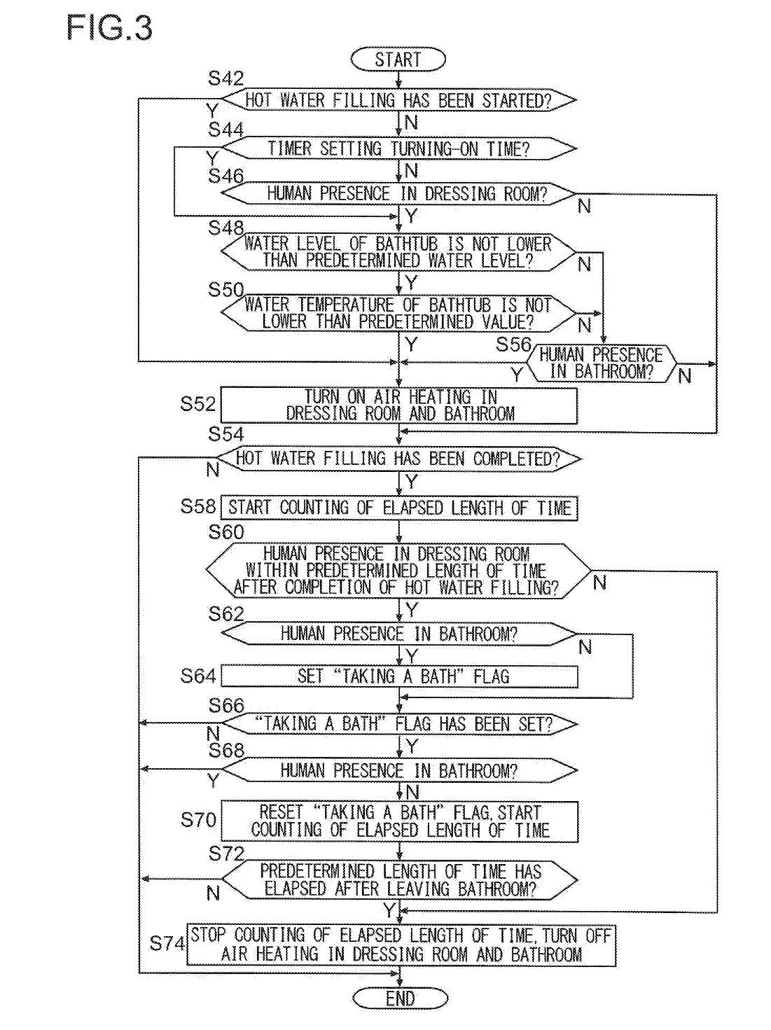

FIG. 3 is a flow chart showing a detail of the dressing room • bathroom air heating automatic control process at Step S14 in FIG. 2. Upon the start of a flow, at Step S42, it is checked whether or not hot water filling into the bathtub 34 has been started. When the start of the hot water filling is not detected, an advance is made to Step S44 at which it is checked whether or not the air heating turning-on time set by using the timer has arrived. When the timer setting turning-on time is not detected, a transition is made to Step S46 at which entry of the resident into the dressing room 8 is checked by the human presence sensor 52.

When human presence is detected, an advance is made to Step S48 at which it is checked by the water level sensor 42 that the bathtub 34 has been filled to a predetermined water level. This is performed for the purpose of judging that when the bathtub 34 is not at the predetermined water level, assumedly, the reason for the resident's entry into the dressing room 8 is not to take a bath. When the bathtub 34 is at a water level not lower than the predetermined water level, an advance is made to Step S50 at which it is checked by the water temperature sensor 44 whether or not a water temperature of the bathtub 34 is not lower than a predetermined value. This is performed for the purpose of judging that when the water temperature of the bathtub 34 does not have a value not lower than the predetermined value, assumedly, the reason for the resident's entry into the dressing room 8 is not to take a bath. The dressing room 8 is used also as a space for installing a wash-basin and a washing machine, and entry into the dressing room 8 for the purposes of using these does not involve undressing and thus is less dangerous. Based on this, Step S48 and Step S50 are performed for the purpose of excluding such cases. When, at Step S44, arrival of the timer setting turning-on time is detected, regardless of whether or not human presence is detected, a transition is made to Step S48. Although use of the timer is intended basically for turning on air heating, as a precaution, the checking at each of Step S48 and Step S50 is performed so that useless air heating is prevented from being turned on despite the bathtub 34 not being in a state ready for taking a bath.

When, at Step S50, it is found that the water temperature of the bathtub 34 is not lower than the predetermined value, there is a high possibility that the reason for the resident's entry into the dressing room 8 is to take a bath, in which case an advance is made to Step S52 at which the air heating portion 46 of the dressing room 8 and the air heating portion 36 of the bathroom 6 are automatically turned on, after which an advance is made to Step S54. Aside from a case where, based on arrival of the timer setting turning-on time, Step S52 is reached via Step S48 and Step S50, in a case where Step S52 is reached based on detection of human presence at Step S46, the room temperature does not rise abruptly, and thus, as will be described later, the warning to refrain from getting undressed is to be given. In contrast, in a case where, at Step S42, the start of hot water filling is detected, a transition is immediately made to Step S52. In this case, air heating is continued over a length of time required for the hot water filling, and thus it is expected that the dressing room 8 also has been heated up at a point in time when the hot water filling is completed.

On the other hand, in a case where, at Step S48, it is detected that the bathtub 34 is at a water level not higher than the predetermined water level or in a case where, at Step S50, it is detected that the water temperature of the bathtub 34 is not higher than the predetermined value, an advance is made to Step S56 at which it is checked by the human presence sensor 38 whether or not the resident has entered the bathroom 6. This is performed for the purpose of detecting a case where the resident has erroneously entered the bathroom 6 despite the bathroom 6 not being in a state ready for taking a bath and has also been undressed (in disregard of the warning), thus being in an extremely dangerous state. In this case, an advance is made to Step S52 at which air heating in each of the dressing room 8 and the bathroom 6 is hastily turned on. In a case where, at Step S46, human presence in the dressing room 8 is not detected, there is no need to start air heating at the moment, and thus an advance is made directly to Step S54. Also in a case where, at Step S56, no human presence is detected (a normal case), similarly, an advance is made directly to Step S54.

At Step S54, it is checked by the water level sensor 42 and the water temperature sensor 44 whether or not a hot water filling completed state has been reached. When completion of hot water filling is detected, an advance is made to Step S58 from which point in time counting of an elapsed length of time is started. Then, at Step S60, it is checked whether or not human presence in the dressing room 8 has been detected within a predetermined length of time after the completion of hot water filling. When human presence has been detected within the predetermined length of time, an advance is made to Step S62 at which it is checked whether or not human presence in the bathroom 6 has been detected. When human presence in the bathroom 6 has been detected, it is meant that the resident (regardless of whether he/she has been in a safe state or he/she has disregarded the warning) has been undressed and taken a bath, in which case an advance is made to Step S64 at which a “taking a bath” flag is set, after which an advance is made to Step S66. When, at step S62, no human presence is detected, an advance is made directly to Step S66.

At Step S66, it is checked whether or not the “taking a bath” flag has been set, and upon confirming that the flag has been set, checking of human presence in the bathroom 6 at Step S68 is implemented. Then, when human presence is no longer detected, it is meant that the resident, who had been taking a bath, has left the bathroom 6, in which case an advance is made to Step S70 at which the “taking a bath” flag is reset, and counting of an elapsed length of time thereafter is started, after which a transition is made to Step S72. This is performed for the purpose of, as will be described later, using this timing as a guideline for turning off useless air heating after a lapse of a predetermined length of time after taking a bath.

At Step S72, it is checked whether or not a predetermined length of time has elapsed after leaving the bathroom. Then, when the predetermined length of time has elapsed, an advance is made to Step S74 at which counting of an elapsed length of time is halted and air heating in each of the dressing room 8 and the bathroom 6 is turned off to end the flow. This is because a sufficient length of time for getting dressed after taking a bath has elapsed, and thus it is considered useless to continue air heating any longer. Furthermore, also when, at Step S60, it is confirmed that the predetermined length of time has elapsed without detecting human presence in the dressing room 8 after the completion of hot water filling, a transition is made to Step S74 at which the counting of an elapsed length of time is halted and air heating in each of the dressing room 8 and the bathroom 6 is turned off to end the flow. This is because it is unreasonable to continue air heating for a long length of time without the resident taking a bath after the completion of hot water filling. On the other hand, when, at Step S54, completion of hot water filling is not detected, when, at Step S66, setting of the “taking a bath” flag cannot be detected, when, at Step S68, human presence in the bathroom 6 has been continuously detected, or when, at Step S72, it is not detected that the predetermined length of time has elapsed after the resident had left the bathroom 6, none of these cases refers to a situation in which air heating in each of the dressing room 8 and the bathroom 6 should be turned off, and thus the flow is directly ended. While, as described above, the flow in FIG. 3 includes control of turning off air heating, most common occasions for turning off air heating is when the dressing room 8 has been heated up or when a temperature difference between the dressing room 8 and the living room 4 has been corrected, and Step S32 in FIG. 2 functions for this purpose.

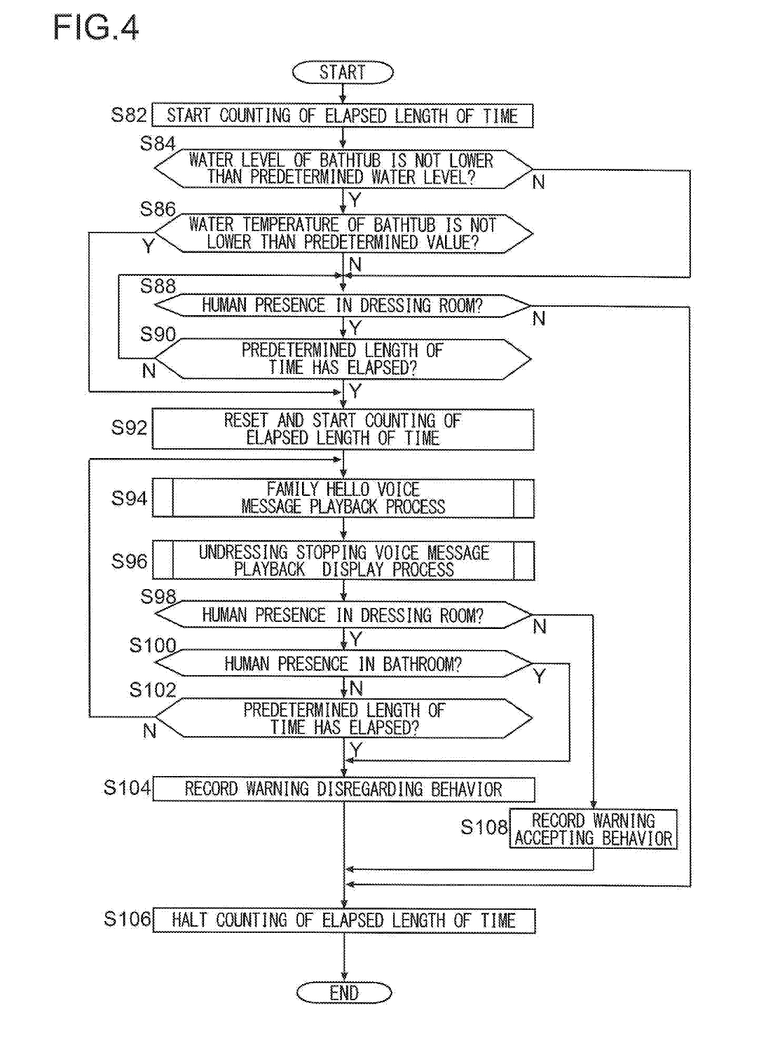

FIG. 4 is a flow chart showing a detail of the personal warning process at Step S18 in FIG. 2. Upon the start of a flow, at Step S82, there is started counting of an elapsed length of time since detection of human presence in the dressing room 8 at Step S16, after which a transition is made to Step S84. At Step S84, in a similar manner to that at Step S48 in FIG. 3, it is checked whether or not the bathtub 34 has been filled to a predetermined water level. When the bathtub 34 is at a water level not lower than the predetermined water level, an advance is made to Step S86 at which, in a similar manner to that at Step S50 in FIG. 3, it is checked whether or not a water temperature of the bathtub 34 is not lower than a predetermined value. Then, when the water temperature does not have a value not lower than the predetermined value, an advance is made to Step S88. On the other hand, also in a case where, at Step S84, it is found that the bathtub 34 is not at a water level not lower than the predetermined water level, an advance is made to Step S88.

At Step S88, human presence in the dressing room 8 is checked again, and when human presence has been continuously detected, an advance is made to Step S90 at which, based on the time counting started at Step S82, it is checked whether or not a predetermined length of time or more has elapsed since the start of first detection of human presence. Then, when such a lapse of time is confirmed, there is a possibility that the resident has erroneously started getting undressed despite a situation ready for taking a bath not being established, in which case a transition is made to Step S92. When, at Step S90, it is found that the predetermined length of time has not elapsed, a return is made to Step S88 at which until a lapse of the predetermined length of time, checking of whether or not human presence is continuously detected is continued. On the other hand, when, at Step S86, it is confirmed that the water temperature is not lower than the predetermined value, it is conceived that the resident has entered the dressing room 8 to take a bath, in which case a transition is made directly to Step S92.

At Step S92, the time counting that has been continued thus far is reset, and another round of time counting is started. Then, an advance is made to Step S94 at which a process of playing back a hello voice message of the family is performed. This is performed for the purpose of creating, prior to the warning, a warning accepting mentality by using a hello from the family. Next, at Step S96, a warning voice message to stop the resident from getting undressed is played back, and a process of, for example, causing blinking of the display portion 50 is performed. Next, an advance is made to Step S98 at which human presence in the dressing room 8 is checked again. When human presence has been continuously detected, an advance is made to Step S100 at which human presence in the bathroom 6 is checked. When human presence in the bathroom 6 is not detected, an advance is made to Step S102 at which, based on the time counting started at Step S92, it is checked whether or not a predetermined length of time has elapsed. Then, when the predetermined length of time has elapsed, it is assumed that the resident has already gotten undressed in disregard of the warning, in which case an advance is made to Step S104. On the other hand, when the predetermined length of time has not elapsed, a return is made to Step S94, after which unless the predetermined length of time elapses while human presence in the dressing room 8 is continuously detected, Step S94 to Step S102 are repeatedly performed. On the other hand, when, at Step S100, human presence in the bathroom 6 is detected, it is meant that the resident has already gotten undressed, in which case an advance is immediately made to Step S104.

At Step S104, a history of a behavior of having gotten undressed in disregard of the warning is recorded, after which an advance is made to Step S106. On the other hand, in a case where, at Step S98, it is detected that human presence in the dressing room 8 has become no longer detected within a predetermined length of time, it is conceived that the resident has accepted the warning and dissuaded himself/herself from getting undressed, in which case an advance is made to Step S108 at which a history of such a behavior of having accepted the warning is recorded, after which an advance is made to Step S106. Furthermore, when, at Step S88, human presence in the dressing room 8 has become no longer detected within a predetermined length of time, it is meant that, with the understanding that a situation ready for taking a bath has not been established, the resident has left the dressing room 8 or that an original reason for entry into the dressing room 8 is not to get undressed, in which case a transition is made to Step S106. At Step S106, the counting of an elapsed length of time is halted to end the flow.

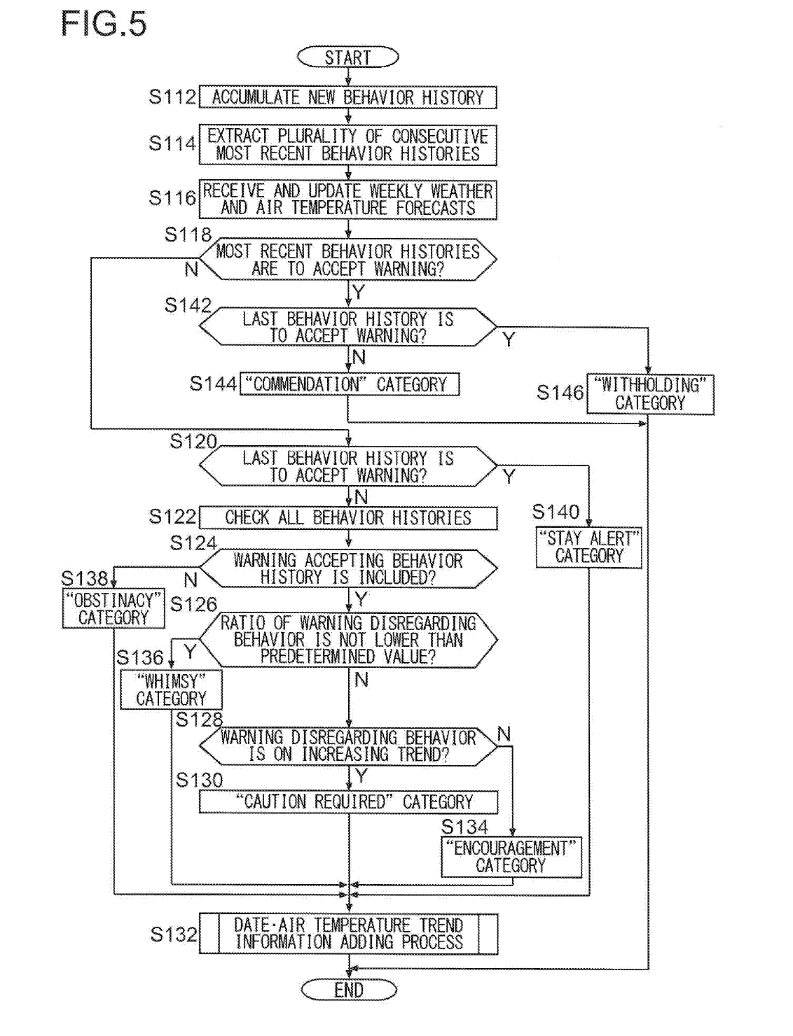

FIG. 5 is a flow chart showing a detail of a behavior history accumulation • analysis process at Step S22 in FIG. 2. Upon the start of a flow, at Step S112, a new behavior history, if any, is accumulated, after which an advance is made to Step S114 at which a plurality of consecutive most recent behavior histories are extracted. Moreover, at Step S116, by the communication portion 20, a weekly weather forecast and a weekly air temperature forecast are received from an external database, based on which forecast memory of the storage portion 34 for storing a history, etc. is updated.

Next, at Step S118, it is checked whether or not the most recent behavior histories thus extracted are to accept the warning (to stop getting undressed). When the most recent behavior histories are not to accept the warning, an advance is made to Step S120 at which it is checked whether or not a last behavior history extracted is to accept the warning. Then, when the last behavior history also is not to accept the warning, all behavior histories stored are checked, after which an advance is made to Step S124 at which it is checked whether or not all the behavior histories include a history of a warning accepting behavior. When the history of a warning accepting behavior is included, an advance is made to Step S126 at which it is checked whether or not a ratio of a warning disregarding (getting undressed) behavior history has increased to a value not lower than a predetermined value (for example, not lower than 30%). When this ratio is not higher than the predetermined value, an advance is made to Step S128 at which it is checked whether or not a disregarding behavior recently exhibited is on an increasing trend, though the ratio thereof as a whole remains low. When there is such an increasing trend, an advance is made to Step S130 at which a result of a behavior analysis is determined to fall under a “‘caution required’ category”, after which a transition is made to Step S132. Under this behavior category, a person to be watched is determined to have gradually become accustomed to the warning and gotten into the habit of considering it less important, thus being at a higher risk.

On the other hand, when, at Step S128, it is confirmed that the disregarding behavior recently exhibited is not on an increasing trend, an advance is made to Step S134 at which a result of the behavior analysis is determined to fall under an “‘encouragement’ category”, after which a transition is made to Step S132. Under this behavior category, the ratio of the warning disregarding behavior as a whole is small and is also not on an increasing trend, and thus the person to be watched is determined to have relatively a tendency of respecting the warning and would listen to an encouragement to further respect the warning.

Furthermore, in a case where, at Step S126, it is confirmed that the ratio of the warning disregarding (getting undressed) behavior history has increased to a value not lower than the predetermined value (for example, not lower than 30%), an advance is made to Step S136 at which a result of the behavior analysis is determined to fall under an “‘whimsy’ category”, after which a transition is made to Step S132. Under this behavior category, the ratio of the warning disregarding behavior as a whole is large, and thus the person to be watched is determined to have basically a tendency of considering the warning less important, though may obey it on a whim.

Moreover, in a case where, at Step S124, it is confirmed that all the behavior histories include no history of a warning accepting behavior at all, an advance is made to Step S138 at which a result of the behavior analysis is determined to fall under a “‘obstinacy’ category”, after which a transition is made to Step S132. Under this behavior category, the person to be watched is determined to be an obstinate person who would not listen to the warning at all.

In a case where, at Step S120, it is judged that the last behavior history extracted is to accept the warning, an advance is made to Step S140 at which a result of the behavior analysis is determined to fall under a “‘stay alert’ category”, after which a transition is made to Step S132. Under this behavior category, although the person to be watched has disregarded the warning this time, he/she had accepted it last time, and thus it is determined that he/she basically considers the warning important but just has happened to be careless enough to disregard the warning this time.

Step S132 is a process of adding, as materials to be used for persuasion into accepting the warning, date information based on a date • clock function of the controller 10 and air temperature trend information based on the weekly weather • air temperature forecast updated at Step S116, and completion of this process ends the flow, after which a transition is made to Step S24 in FIG. 2. That is, in all cases where Step S132 is reached, as the most recent behavior histories, the person to be watched has disregarded the warning and thus is required to be persuaded into accepting the warning from the next time on, for which purpose, as effective persuasion materials, a fact that, date-wise, the cold season is on the way and a fact that a forecast indicating a decreasing air temperature trend has actually been issued are added to a determined one of the categories, respectively. Use of the information added at Step S132 will be described later.

In contrast, in a case where, at Step S118, it is confirmed that the most recent behavior histories extracted are to accept the warning, an advance is made to Step S142 at which it is checked whether or not the last behavior history also is to accept the warning. Then, when the last behavior history is not to accept the warning, it is meant that the person to be watched, who had disregarded the warning last time, has changed his/her mind this time and accepted the warning, in which case an advance is made to Step S144 at which a result of the behavior analysis is determined to fall under a “‘commendation’ category”, and the step flow is immediately ended, after which a transition is made to Step S24 in FIG. 2. That is, under this category, it is sufficient to commend the warning accepting behavior exhibited most recently, and it would be counterproductive to harp on persuasion information, for which reason, Step S132 is not gone through.

Furthermore, when, at Step S142, it is confirmed that the last behavior history also is to accept the warning, the person to be watched has a tendency of observing the warning, and thus it would be impolite to send him/her a needless message, in which case an advance is made to Step S146 at which a result of the behavior analysis is determined to fall under a “‘withholding’ category”, and the step flow is immediately ended, after which a transition is made to Step S24 in FIG. 2. Also under this category, Step S132 is not gone through, and, as will be described later, sending any impolite message to the person to be watched is withheld.

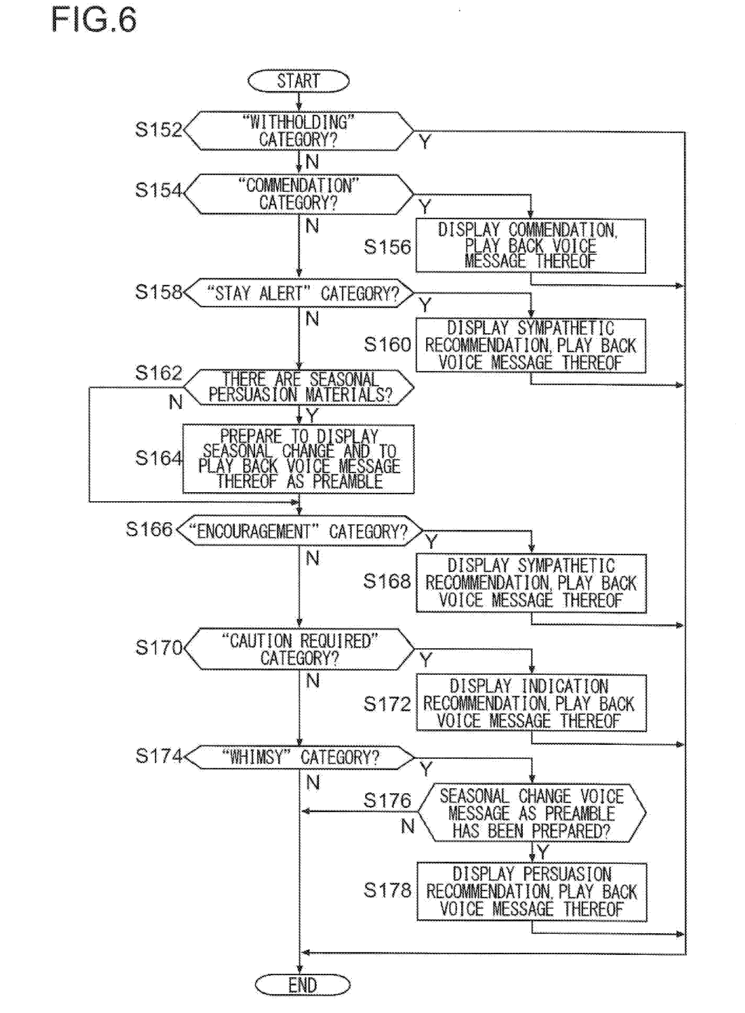

FIG. 6 is a flow chart showing a detail of the personal persuasion process at Step S24 in FIG. 2. This process is a process for conveying a message such as appropriate persuasion to the person to be watched in accordance with the categories described with reference to FIG. 5. Upon the start of a flow, first at Step S152, it is checked whether or not the determined category is the “‘withholding’ category”. When the determined category is the “‘withholding’ category”, conveying a message to the person to be watched is withheld, and the flow is immediately ended, after which a transition is made to Step S26 in FIG. 2.

On the other hand, when, at Step S152, it is judged that the determined category is not the “‘withholding’ category”, an advance is made to Step S154 at which it is checked whether or not the determined category is the “‘commendation’ category”. Then, when the determined category is the “‘commendation’ category”, an advance is made to Step S156 at which a commendation voice message prepared beforehand such as, for example, a message “Thank you for your effort in avoiding the danger. We will continue to provide you with appropriate information.” is played back, and display to the same effect is performed to end the flow.

Furthermore, when, at Step S154, it is judged that the determined category is not the “‘commendation’ category”, an advance is made to Step S158 at which it is checked whether or not the determined category is the “‘stay alert’ category”. Then, when the determined category is the “‘stay alert’ category”, an advance is made to Step S160 at which a sympathetic recommendation voice message prepared beforehand such as a message “Always stay alert and careful. Please keep respecting the warning as you always have.” is played back, and display to the same effect is performed to end the flow.

In contrast, when, at Step S158, it is judged that the determined category is not the “‘stay alert’ category”, an advance is made to Step S162 at which it is checked whether or not there are seasonal change persuasion materials based on the date • air temperature trend information added at Step S132 in FIG. 5. Then, when there are such seasonal change persuasion materials, an advance is made to Step S164 at which a seasonal change voice message such as, for example, a date-based voice message “It is the first day of winter according to the calendar.” or an air temperature trend information-based message “Chilly mornings and evenings have been forecast.” is prepared for playback, and display to the same effect is prepared, after which a transition is made to Step S166. On the other hand, when, at Step S162, it is confirmed that there are no seasonal change persuasion materials, a transition is made directly to Step S166. As will be described later, a voice message and display prepared at Step S164 are to be played back as a preamble to a recommendation voice message so as to reinforce persuasiveness of a recommendation to accept the warning.

At Step S166, it is checked whether or not the determined category is the “‘encouragement’ category”. Then, when the determined category is the “‘encouragement’ category”, an advance is made to Step S168 at which the sympathetic recommendation voice message prepared beforehand such as the message “Always stay alert and careful. Please keep respecting the warning as you always have.” is played back, and display to the same effect is performed to end the flow. At this time, in a case where, at Step S164, a seasonal change voice message has been prepared as a preamble, an entire voice message to be played back is, for example, a message “Chilly mornings and evenings have been forecast. Always stay alert and careful. Please keep respecting the warning as you always have.”

On the other hand, when, at Step S166, it is judged that the determined category is not the “‘encouragement’ category”, an advance is made to Step S170 at which it is checked whether or not the determined category is the “‘caution required’ category”. Then, when the determined category is the “‘caution required’ category”, an advance is made to Step S172 at which an indication recommendation voice message prepared beforehand such as a message “It is dangerous to expose your body to a sharp temperature difference. Please respect the warning.” is played back, and display to the same effect is performed to end the flow. At this time, in a case where, at Step S164, a seasonal change voice message has been prepared as a preamble, an entire voice message to be played back is, for example, a message “Chilly mornings and evenings have been forecast. It is dangerous to expose your body to a sharp temperature difference. Please respect the warning.”

Furthermore, when, at Step S170, it is judged that the determined category is not the “‘caution required’ category”, an advance is made to Step S174 at which it is checked whether or not the determined category is the “‘whimsy’ category”. Then, when the determined category is the “‘whimsy’ category”, an advance is made to Step S176 at which it is checked whether or not a seasonal change voice message has been prepared as a preamble at Step S164. Then, in a case where the seasonal change voice message has been prepared as a preamble, an advance is made to Step S178 at which, for example, a persuasion voice message “Chilly mornings and evenings have been forecast. For your own protection, please obey the warning.” is played back, and display to the same effect is performed to end the flow.

On the other hand, in a case where, at Step S176, it is not confirmed that the seasonal change voice message has been prepared as a preamble, without making any recommendation, the flow is immediately ended, after which a transition is made to Step S26 in FIG. 2. This means that, in a case of a person to be watched falling under the “‘whimsy’ category”, it is expected that making an automatic recommendation without using any objective persuasion materials such as those based on a seasonal change has no effect, and thus instead of making such an automatic recommendation, which is possibly counterproductive, handling of this person to be watched is left up to his/her family or a service provider as will be described later. Furthermore, in a case where, at Step S174, it is not confirmed that the determined category is the “‘whimsy’ category”, it is meant that the determination category is the “‘obstinacy’ category”, and also in this case, similarly, without making any recommendation, the flow is immediately ended, after which a transition is made to Step S26 in FIG. 2, so that handing of the person to be watched is left up to the family or the service provider as will be described later.

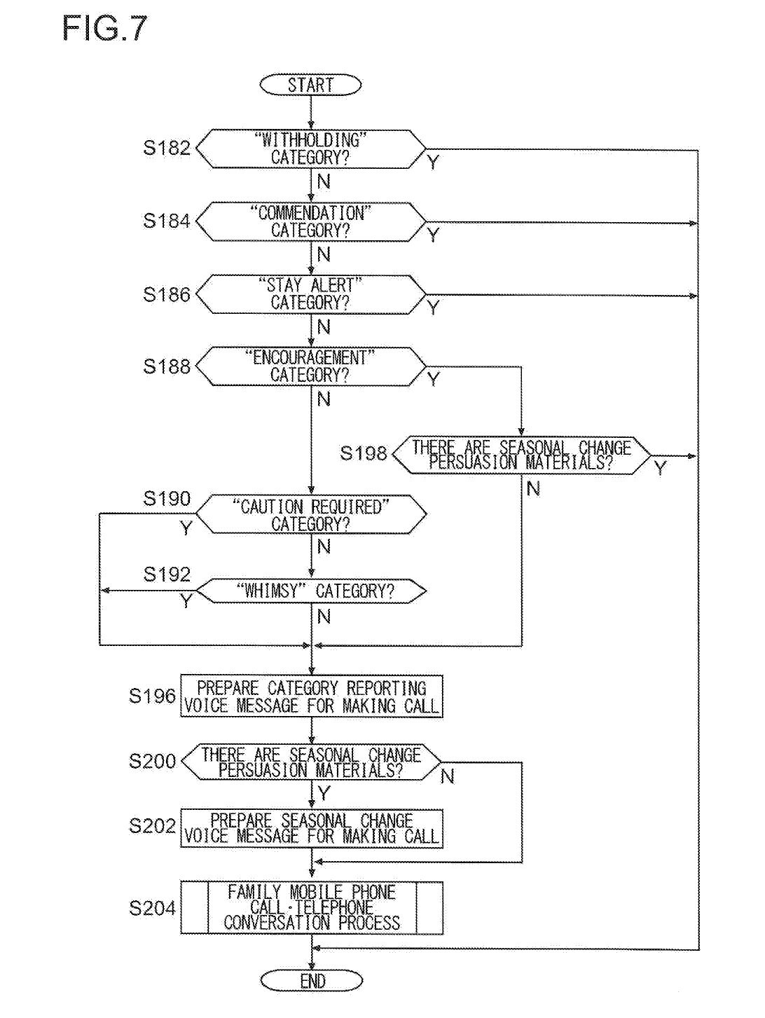

FIG. 7 is a flow chart showing a detail of the family reporting cooperation process at Step S26 in FIG. 2. This process is a process in which a behavior of the person to be watched is automatically reported, by the communication portion 20, to the mobile phone 22 of the family at a remote location so that based thereon, the person to be watched is persuaded through a telephone conversation via the mobile phone 22 of the family at a remote location and the microphone 12 and the speaker 14 in the living room 4. Upon the start of a flow in FIG. 7, first, at Step S182, it is checked whether or not the determined category is the “‘withholding’ category”, and when the determined category is the “‘withholding’ category”, without automatically reporting to the family, the flow is immediately ended, after which a transition is made to Step S28 in FIG. 2.

On the other hand, when, at Step S182, it is judged that the determined category is not the “‘withholding’ category”, an advance is made to Step S184 at which it is checked whether or not the determined category is the “‘commendation’ category”. Then, also in a case where the determined category is the “‘commendation’ category”, without automatically reporting the family, the flow is immediately ended, after which a transition is made to Step S28 in FIG. 2. Furthermore, when, at Step S184, it is judged that the determined category is not the “‘commendation’ category”, an advance is made to Step S186 at which it is checked whether or not the determined category is the “‘stay alert’ category”. Then, also in a case where the determined category is the “‘stay alert’ category”, without automatically reporting to the family, the flow is immediately ended, after which a transition is made to Step S28 in FIG. 2. Under these categories, with reliance on the autonomy of the person to be watched himself/herself, the family is not unnecessarily mobilized.

In contrast, when, at Step S186, it is judged that the determined category is not the “‘stay alert’ category”, an advance is made to Step S188 at which it is checked whether or not the determined category is the “‘encouragement’ category”. Then, in a case where the determined category is not the “‘encouragement’ category”, an advance is made to Step S190 at which it is checked whether or not the determined category is the “‘caution required’ category”. Moreover, in a case where the determined category is not the “‘caution required’ category, an advance is made to Step S192 at which it is checked whether or not the determined category is the “‘whimsy’ category”. Here, in a case where the determined category is not the “‘whimsy’ category”, it is meant that the determined category is the “‘obstinacy’ category”, in which case, at Step S196, a category reporting voice message for making a call (in this case, with respect to a response to the call, a voice message reporting that the determined category is the “‘obstinacy’ category”) is prepared.

On the other hand, in a case where, at Step S190, it is confirmed that the determined category is the “‘caution required’ category” or also in a case where, at Step S192, it is confirmed that the determined category is the “‘whimsy’ category”, a transition is made to Step S196 at which a category reporting voice message for making a call (in each of these cases, with respect to a response to the call, a voice message reporting that the determined category is the “‘caution required’ category” or the “‘whimsy’ category”) is prepared.

Furthermore, in a case where, at Step S188, it is confirmed that the determined category is the “‘encouragement’ category”, a transition is made to Step S198 at which it is checked whether or not there are seasonal change persuasion materials. Then, when there are seasonal change persuasion materials, the flow is immediately ended, after which a transition is made to Step S28 in FIG. 2. In a case where under the “‘encouragement’ category”, persuasion can be made more realistic by using available seasonal change persuasion materials, the automatic persuasion with respect to the person to be watched himself/herself described with reference to FIG. 6 is adopted, and the family is not mobilized. In contrast, in a case where, at Step S198, it is not confirmed that there are seasonal change persuasion materials, an advance is made to Step S196 at which a category reporting voice message for making a call (in this case, with respect to a response to the call, a voice message reporting that the determined category is the “‘encouragement’ category”) is prepared. As described above, in the case where there are no seasonal change persuasion materials, there is no expected effect in providing perfunctory automatic persuasion to the person to be watched, and thus the family is mobilized.

Upon completion of the preparation of the category reporting voice message for making a call at Step S196, an advance is made to Step S200 at which it is checked whether or not there are seasonal change persuasion materials. Then, when there are seasonal change persuasion materials, an advance is made to Step S202 at which a seasonal change voice message for making a call is prepared, after which a transition is made to Step S204. In a case where, at Step S200, it is not confirmed that there are seasonal change persuasion materials, a transition is made directly to Step S204.

At Step S204, a call to the mobile phone 22 of the family at a remote location registered beforehand is made, with respect to a response thereto, an automatic voice report to the mobile phone 22 is made, and a succeeding process of holding a telephone conversation between the person to be watched and his/her family at a remote location is performed. Then, when the telephone conversation is disconnected, such a family mobile phone call • telephone conversation process at Step S204 is completed to end the flow, after which a transition is made to Step S28 in FIG. 2. Also in a case where there is no response from the mobile phone 22 of the family at a remote location to the call being requested for a predetermined length of time, the family mobile phone call • telephone conversation process at Step S204 is ended, after which a transition is made to Step S28 in FIG. 2.

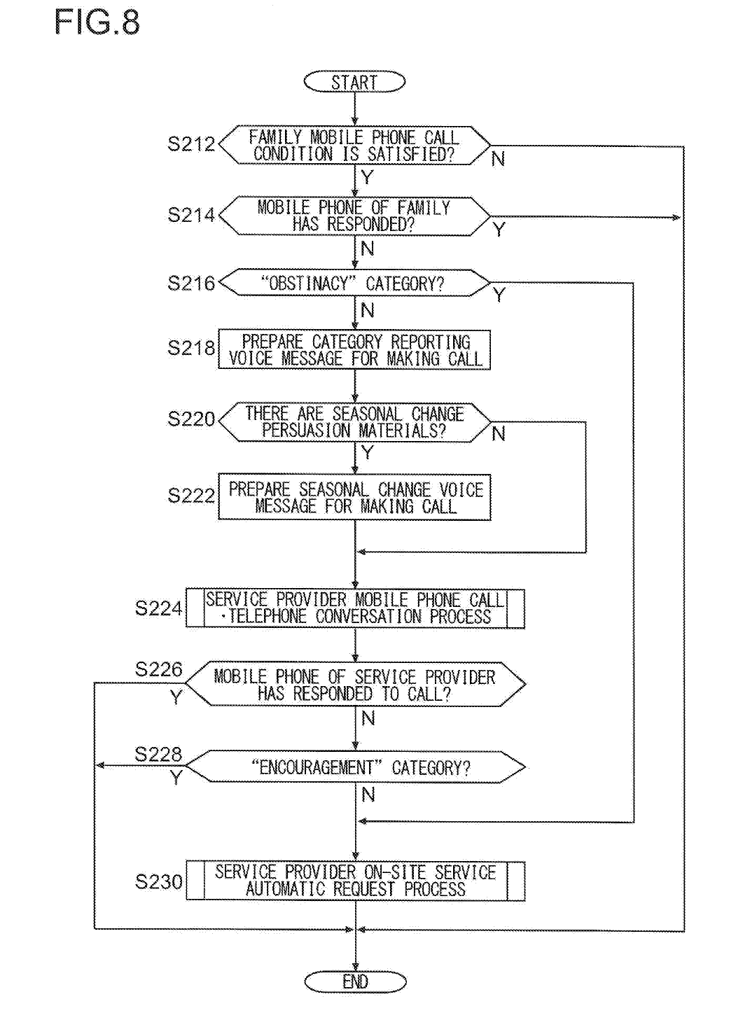

FIG. 8 is a flow chart showing a detail of the service provider reporting process at Step S28 in FIG. 2, in which a dangerous behavior is automatically reported, by the communication portion 20, from the system to the mobile phone 22 of the watch service provider, based thereon, a persuasion back-up process is performed through a telephone conversation via the mobile phone 24 of the watch service provider and the microphone 12 and the speaker 14 in the living room 4, and an on-site service automatic request process of automatically requesting an on-site service at the house 2 from the system to the watch service provider is performed.

Upon the start of a flow in FIG. 8, first, at Step S212, it is checked whether or not a result of the analysis conforms to a family mobile phone call condition. Conforming to the family mobile phone call condition refers to a case of satisfying a condition for reaching Step S204 in FIG. 7. When the family mobile phone call condition is not satisfied at Step S212 in FIG. 8, it is meant that there is no need for cooperation of the family, let alone the need to seek cooperation of the watch service provider, and thus the flow is immediately ended, after which a transition is made to Step S30 in FIG. 2.

On the other hand, in a case where, at Step S212, it is confirmed that a result of the analysis conforms to the family mobile phone call condition, an advance is made to Step S214 at which, in accordance with the flow in FIG. 7, it is checked whether or not the mobile phone 22 of the family at a remote location has responded. In a case where the mobile phone 22 of the family at a remote location has responded, handling of the person to be watched is left up to the family at a remote location, and this is not a situation for the watch service provider to get involved, in which case the flow is immediately ended, after which a transition is made to Step S30 in FIG. 2.

In contrast, in a case where, at Step S214, the mobile phone 22 of the family at a remote location has not responded, it is meant that the person to be watched has not been taken care of, in which case an advance is made to Step S216 at which it is checked whether or not the determined category is the “‘obstinacy’ category”. When the determined category is not the “‘obstinacy’ category”, an advance is made to Step S218 at which a corresponding category reporting voice message for making a call is prepared, after which a transition is made to Step S220. At Step S220, it is checked whether or not there are seasonal change persuasion materials, and when there are seasonal change persuasion materials, an advance is made to Step S222 at which a seasonal change voice message for making a call is prepared, after which a transition is made to Step S224. In a case where, at Step S220, it is not confirmed that there are seasonal change persuasion materials, a transition is made directly to Step S224.

At Step S224, a call to the mobile phone 24 of the watch service provider registered beforehand is made, with respect to a response thereto, an automatic voice report to the mobile phone 24 is made, and a succeeding process of holding a telephone conversation between the person to be watched and the watch service provider is performed. Then, in a case where the telephone conversation is disconnected or there is no response from the mobile phone 24 of the watch service provider to the call being requested for a predetermined length of time, a service provider mobile phone call • telephone conversation process at Step S224 is ended, after which a transition is made to Step S226.

At Step S226, it is checked whether or not, at Step S224, the mobile phone 24 of the watch service provider has responded to the call, and in a case where there has been no response, an advance is made to Step S228 at which it is checked whether or not the determined category is the “‘encouragement’ category”. Then, when the determined category is not the “‘encouragement’ category”, care by the watch service provider as an alternative to the response from the mobile phone 24 is indispensable, in which case a transition is made to Step S230 at which the automatic request process of requesting an on-site service of the service provider. Then, completion of such a service provider on-site service automatic request process at Step S230 ends the flow, after which a transition is made to Step S30 in FIG. 2.

Furthermore, when, at Step S216, it is found that the determined category is the “‘obstinacy’ category”, the possibility of successful persuasion through telephone communication is slim, and thus a transition is immediately made to the service provider on-site service automatic request process at Step S230. Furthermore, when, at Step S212, it is confirmed that the family mobile phone call condition is not satisfied or when, at Step S214, it is confirmed that there has been a response from the mobile phone 22 of the family at a remote location, there is no need for care of the watch service provider, and thus the flow is immediately ended, after which a transition is made to Step S30 in FIG. 2. Furthermore, when, at Step S226, it is confirmed that there has been a response from the mobile phone 24 of the watch service provider to the call or when, at Step S228, it is confirmed that the determined category is the “‘encouragement’ category”, in each of these cases, the service provider on-site service automatic request process at Step S230 is omitted to end the flow, after which a transition is made to Step S30 in FIG. 2.

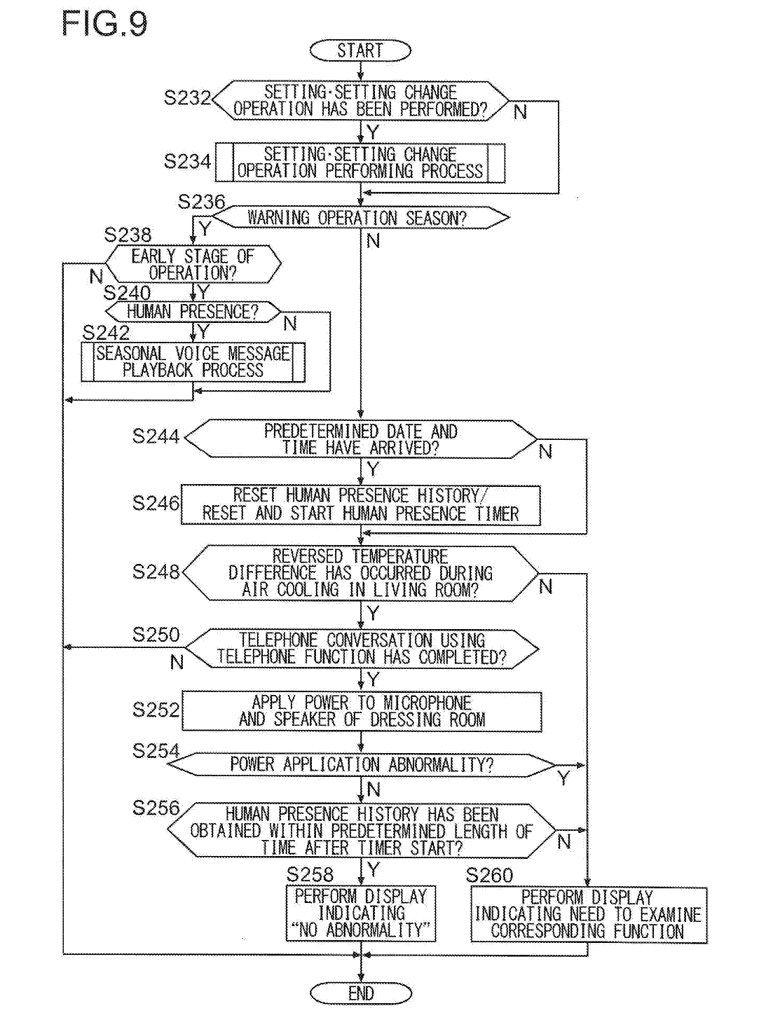

FIG. 9 is a flow chart showing a detail of the function setting • testing process at Step S30 in FIG. 2, in which various settings for operation conditions including, for example, setting of an air heating turning-on time on the timer and changes thereto are made by the operation portion 16 and the display portion 18, and it is checked on a routine basis whether or not the measures to prevent occurrence of a heat shock, which do not function for a long period of time including a summer season, would operate properly when a winter season has come. Upon a start of a flow, at Step S232, it is checked whether or not a setting operation or a setting change operation has been performed, and when either of these operations is detected, a transition is made to Step S234 at which a setting • setting change operation performing process is performed, after which a transition is made to Step S236. On the other hand, when, at Step S232, neither of the operations is detected, a transition is made directly to Step S236.

At Step S236, based on the date • clock function of the controller 10, it is checked whether or not a present point in time is in a warning operation season (for example, between November to March). Then, when the present point in time is in the warning operation season, a transition is made to Step S238 at which it is checked whether or not the present point in time is at an early stage of operation (for example, the first week of November). When the present point in time is at the early stage of operation, a transition is made to Step S240 at which it is checked by the human presence sensor 52 whether or not the person to be watched has entered the dressing room 8. Then, when such entry is detected, an advance is made to Step S242 at which a seasonal voice message playback process is performed to end the flow. In the seasonal voice message playback process at Step S242, at the early stage of operation, a voice message such as a message “The season of chilly mornings and evenings has come. Please pay attention to a temperature difference from the temperature at the living room.” is played back every time the person to be watched enters the dressing room 8. This reminds the person to be watched of a warning observing behavior, which has not been exhibited during a long-term warning non-operation season (for example, from April to October). When, at Step S238, it is found that the early stage of operation has passed or when, at Step S240, no human presence is detected, the flow is immediately ended. Upon the end of the flow in FIG. 9, a transition is made to Step S36 in FIG. 2.

On the other hand, when, at Step S236, it is confirmed that the present point in time is not in the warning operation season, a transition is made to a testing function at Step S244 and thereafter. At Step S244, based on the date • clock function of the controller 10, it is checked whether or not a predetermined day and time has arrived (in this case, whether or not, instead of an absolute date and time, a repeated cycle such as, for example “noon that occurs once every three days” has elapsed). Then, when the predetermined date and time has arrived, an advance is made to Step S246 at which human presence histories within the above-described repeated cycle are reset and a human presence timer that measures a lapse of the above-described repeated cycle is reset to make a new start, after which a transition is made to Step S248. On the other hand, when, at Step S244, it is found that the predetermined date and time has not arrived, a transition is made directly to Step S248. In this manner, a predetermined length of time as a guideline for checking a human presence sensor function, which will be described later, is managed.

At Step S248, it is checked whether or not, in a summer season or the like, air cooling has been performed by the air conditioner portion 26 of the living room 4, and whether or not, as a result thereof, there has occurred a naturally expected phenomenon of a reversed temperature difference between the living room 4 and the dressing room 8 (as opposed to the time of detecting a heat shock risk when it is checked that a temperature of the dressing room 8 becomes lower than a temperature of the living room 4, a phenomenon that, in a summer season, as a result of performing air cooling of the living room 4, the temperature of the dressing room 8 having no air cooling equipment reversely becomes higher than the temperature of the living room 4). Then, when, as expected, there has occurred a reversed temperature difference, an advance is made to Step S250. At Step S248, similarly, a phenomenon of a reversed temperature difference between the living room 4 and the bathroom 8 also is checked. Accordingly, an advance is made to Step S250 in a case where, with respect to both of the dressing room 8 and the bathroom 6, there has occurred a phenomenon of a reversed temperature difference. Then, detection of such a reversed temperature difference phenomenon is used as one indicator indicating that the room temperature sensor 28 of the living room 4, the room temperature sensor 54 of the dressing room 8, and the room temperature sensor 40 of the bathroom 6 all function properly.

At Step S250, it is detected whether or not a daily telephone conversation (irrelevant to watching) using the telephone function of the living room 4 has been completed. This is to confirm whether or not a condition that the person to be watched is at home is satisfied by detecting the completion of the telephone conversation succeeding the telephone conversation. When, at Step S250, such completion of telephone function conversation is detected, an advance is made to Step S252 at which power application for testing to the microphone 56 and the speaker 58 of the dressing room 8 is performed. Then, at Step S254, it is detected whether or not there has occurred any abnormality in performing power application by the controller 10, and when there has occurred no abnormality, an advance is made to Step S256. At Step S256, it is checked whether or not, within a predetermined length of time after a timer start based on the function at Step S246, the human presence sensor 52 of the dressing room 8 and the human presence sensor 38 of the bathroom 6 have obtained a human presence history, respectively. Then, when both of the human presence sensors 52 and 38 have obtained a human presence history, an advance is made to Step S258 at which display indicating “no abnormality” is performed to end the flow, after which a transition is made to Step S36 in FIG. 2. In a case where, at Step S250, the completion of telephone function conversation is not detected, test timing is not ripe, and thus the flow is immediately ended.

As described thus far, with respect to the microphone 56 and the speaker 58 of the dressing room 8, for which some kind of trigger is required to perform testing thereon, completion of telephone conversation using the telephone function is used as one trigger, and concurrently at timing at which the microphone 12 and the speaker 14 of the living room 4 have been used for the telephone conversation, testing is performed on the microphone 56 and the speaker 58 of the dressing room 8.

Furthermore, as for testing on the human presence sensor 52 of the dressing room 8 and the human presence sensor 38 of the bathroom 6, since it is not clear whether the reason why there is no detection output from the human presence sensors 52 and 38 is abnormality in the human presence sensors 52 and 38 or a long-term absence of the person to be watched, information that telephone conversation using the telephone function has completed is used to confirm that the person to be watched is at home, and in a case where the person to be watched is at home, when, for three days at the longest, there has been no human presence output in the dressing room 8 or the bathroom 6, which is naturally expected to be used, it is judged that there is abnormality in the human presence sensors 52 and 38.

On the other hand, in a case where, at Step S248, even though air cooling is performed in the living room 4, there occurs no reversed temperature difference, it is judged that any one of the room temperature sensor 28 of the living room 4, the room temperature sensor 54 of the dressing room 8, and the room temperature sensor 40 of the bathroom 6 has not been functioning properly, and an advance is made to Step S260 at which display indicating that it is required to examine a room temperature sensor function is performed to end the flow. As described above, at the time of performing testing on the temperature sensors 28, 54, and 40, a fact that air cooling is being performed is used as a trigger for the testing, and thus without the need to wait for completion of telephone conversation using the telephone function, a transition is made to Step S260.

Furthermore, in a case where, at Step S254, abnormality in performing power application to the microphone 56 and the speaker 58 of the dressing room 8 has been detected, a transition is made to Step S260 at which display indicating that it is required to examine a function in either or both of the microphone 56 and the speaker 58 of the dressing room 8, which has/have power application abnormality, is performed to end the flow.

Moreover, in a case where, at Step S256, after a timer start based on the function at Step S246, within a predetermined length of time, either of the human presence sensor 52 of the dressing room 8 and the human presence sensor 38 of the bathroom 6 has obtained no history of a human presence history, an advance is made to Step S260 at which display indicating that it is required to examine a function in either or both of the human presence sensor 52 and the human presence sensor 38, which has/have no human presence history, is performed to end the flow.

A flow from Step S248 to Step S260 in the above-described testing process shown in FIG. 9 is of such simplicity that items to be examined for possible abnormality are prioritized, and in a case where any higher-ranked item to be examined might have abnormality, testing on items to be examined ranked lower than that is omitted. Further, in this flow, at a point in time when the abnormality in the higher-ranked item to be examined is eliminated, an advance can be made to testing on the items to be examined ranked lower than that. Implementation of the present invention, however, is not limited to such a testing scheme, and a flow is also possible in which items to be examined are treated equally, and independently of whether or not there is abnormality in each other, the items to be examined can be tested one by one for whether or not they have abnormality.

### <Recapitulation>

The following is a recapitulation of various aspects of the present invention disclosed herein.

An invention disclosed herein provides a warning system that is characterized by having a living room temperature sensor that measures a room temperature of a living room, a dressing room temperature sensor that measures a room temperature of a dressing room, and a warning portion that gives a warning when a difference between the room temperature of the living room and the room temperature of the dressing room is not less than a predetermined value. By this configuration, the possibility of occurrence of a heat shock can be reduced.

According to a specific feature, regardless of the difference between the room temperature of the living room and the room temperature of the dressing room, the warning portion gives a warning when the room temperature of the dressing room is not higher than a predetermined value. By this configuration, a more deliberate warning can be given.

According to another specific feature, there are provided an air heating portion that is provided in the dressing room and a control portion that, based on the living room temperature sensor and the dressing room temperature sensor, controls the air heating portion to function when the difference between the room temperature of the living room and the room temperature of the dressing room is not less than a predetermined value. By this configuration, the possibility of occurrence of a heat shock can be reduced more actively.

According to another specific feature, by preparing a bathtub to be ready for taking a bath, the air heating portion is controlled to function. By this configuration, air heating can be started appropriately.

According to another specific feature, a human presence sensor is provided, and based on the human presence sensor, the air heating portion is controlled to function. By this configuration, air heating can be started appropriately.

According to another specific feature, a human presence sensor is provided, and based on the human presence sensor, the warning portion gives a warning. By this configuration, a warning can be given more appropriately.

According to another specific feature, a judgement portion is provided that judges whether or not a user has responded to the warning by the warning portion. By this configuration, for example, in a case where the user disregards the warning, it becomes possible to take a necessary action.

According to another specific feature, a recording portion is provided that records a result of the judgement by the judgement portion. By this configuration, a behavior pattern of the user can be grasped.

According to another specific feature, a communication portion is provided that communicates to an exterior the result of the judgement by the judgement portion. By this configuration, it becomes possible to construct a warning system including a family at a remote location, a watch service provider, and so on.

According to another specific feature, the warning by the warning portion includes a preliminary warning for creating a warning accepting mentality and a full-fledged warning including warning content information. By this configuration, the effect of the warning can be enhanced.

According to another specific feature, a testing unit is provided that, when the difference between the room temperature of the living room and the room temperature of the dressing room does not have a value not lower than the predetermined value, performs testing on the living room temperature sensor, the dressing room temperature sensor, and the warning portion. By this configuration, even at a lapse of a long non-use period of time such as, for example, a summer season, a reliable operation can be guaranteed.

Furthermore, an invention disclosed herein provides a warning system that is characterized by having a warning portion that gives a subject person a warning of a risk of occurrence of a heat shock due to a temperature difference, an accumulation portion that accumulates a behavior history as to whether the subject person has accepted or disregarded the warning by the warning portion, and an analysis portion that analyzes the behavior history accumulated in the accumulation portion. By this configuration, it becomes possible to give more effectively a warning of occurrence of a heat shock to the subject person.

According to a specific feature, based on the behavior history, the analysis portion categorizes the subject person under one of a plurality of categories defined in terms of a risk. By this configuration, it is possible to give a more appropriate warning according to the one of a plurality of categories under which the subject person is categorized. More specifically, based on the result of categorizing, the warning portion changes a content of the warning to the subject person.

According to another specific feature, the warning system has a communication portion that communicates to an exterior, and based on the result of categorizing, the communication portion transmits information from the analysis portion to the exterior. The exterior mentioned here is, for example, a family of the subject person or a watch service provider. By this configuration, for example, persuasion from the exterior becomes possible, and thus an effect of encouraging the subject person to accept the warning can be increased. More specifically, based on the result of categorizing, the communication portion decides whether or not to transmit information from the analysis portion to the exterior. Furthermore, based on the result of categorizing, the communication portion can change a content of communication of the information to be communicated to the exterior. Furthermore, based on the result of categorizing, the communication portion can change a communication destination to which the information from the analysis portion is to be communicated. Furthermore, based on whether or not a first communication destination has responded to the communication, the communication portion can decide whether or not to communicate to a second communication destination.

According to another specific feature, the warning system has a an information acquisition portion that acquires information related to an air temperature change, and based on the information acquisition portion, the warning portion decides whether or not to give a warning. Furthermore, according to another specific feature, the warning system has an information acquisition portion that acquires information related to an air temperature change, and based on the information acquisition portion, the warning portion changes a content of the warning. Furthermore, according to another specific feature, the warning system has an information acquisition portion that acquires information related to an air temperature change, and the communication portion transmits the information from the information acquisition portion to the exterior. More specifically, based on the information acquisition portion, the communication portion decides whether or not to transmit the information from the information acquisition portion to the exterior. Furthermore, based on the information acquisition portion, the communication portion can change a content of communication to the exterior. Furthermore, based on the information acquisition portion, the communication portion can change a communication destination to which the information is to be communicated. The information related to an air temperature change is, for example, a date or an air temperature forecast. According to another specific feature, the warning system has a testing portion that tests a function of the warning portion in any other season than a season in which the warning by the warning portion is required.

According to another feature, a warning system is provided that is characterized by having an information acquisition portion that acquires information related to an air temperature change, a detection portion that detects an air temperature difference, and a warning portion that, based on the information acquisition portion and the detection portion, gives a warning of a risk of occurrence of a heat shock due to an air temperature difference. By taking into consideration such information related to an air temperature change, it becomes possible to reinforce persuasiveness of the warning.

According to a specific feature, based on the information acquisition portion, the warning portion changes a content of the warning. According to another specific feature, the warning system has a communication portion that communicates to the exterior, and based on the information acquisition portion, the communication portion decides whether or not to communicate to the exterior. According to another specific feature, based on the information acquisition portion, the communication portion changes a content of communication to the exterior. According to another specific feature, based on the information acquisition portion, the communication portion changes a communication destination. As described above, based on information related to an air temperature change, a more appropriate warning can be given.

According to another feature, a warning system is provided that is characterized by having a warning portion that gives a subject person a warning of a risk of occurrence of a heat shock due to an air temperature difference, and a testing portion that tests a function of the warning portion in any other season than a season in which the warning by the warning portion is required. By this configuration, it is possible to avoid inconvenience that, for example, the warning portion, which has not functioned for a long period of time from spring through summer to autumn, is found no longer to function in a winter season in which the warning becomes required.

According to a specific feature, the warning portion has a temperature sensor that is provided in each of different rooms, and in the season in which the warning by the warning portion is required, based on a temperature difference detected by the temperature sensor, the warning portion gives a warning of a risk of occurrence of a heat shock, while in any other season than the season in which the warning by the warning portion is required, based on occurrence of a phenomenon of a reversed temperature difference between temperature differences detected by the temperature sensor, the testing portion tests a function of the temperature sensor. By this configuration, for example, the temperature sensor, which is to detect in a winter season a temperature difference between the living room in which air heating is performed and the dressing room, checks in a summer season whether or not, as a result of performing air cooling of the living room, a reverse temperature difference is exhibited, by which also in the summer season, it can be checked that the temperature sensor functions properly.

According to another specific feature, the warning portion has a human presence sensor that is provided in a room in which there is a risk of occurrence of a heat shock, and in any other season than the season in which the warning by the warning portion is required, based on whether or not the human presence sensor detects human presence within a predetermined period of time while the subject person is at home, the testing portion tests a function of the human presence sensor. For example, in a summer season, it is checked whether or not there is a situation in which, even though the subject person is at home, over several days, no human presence has been detected by the human presence sensor, by which also in the summer season, it can be checked whether or not the human presence sensor functions properly.

According to another specific feature, the warning portion has a warning output portion that is provided in a room in which there is a risk of occurrence of a heat shock, and in any other season than the season in which the warning by the warning portion is required, by applying power to the warning output portion, the testing portion tests a function of the warning output portion. By this configuration, it is possible to avoid inconvenience that, for example, the warning output portion, which has not been used for a long period of time, is found no longer to function in a winter season in which the warning becomes required.

According to another feature, a warning system is provided that is characterized by having a warning portion that gives a subject person a warning of occurrence of a heat shock due to an air temperature difference, and at an early stage upon arrival of a season in which the warning by the warning portion is required, the warning portion calls attention to the warning. By this configuration, with regard to an issue of occurrence of a heat shock, which has been left out of consideration for a long period of time, at the beginning of a winter season in which the warning becomes required, it is possible to call attention to the issue.

### INDUSTRIAL APPLICABILITY

The present invention can be applied to a warning system for use in daily life.

### LIST OF REFERENCE SYMBOLS

4 living room
28 living room temperature sensor
8 dressing room
54 dressing room temperature sensor
50, 58 warning portion
46 air heating portion
10 control portion
34 bathtub
52 human presence sensor
10 judgement portion
32 recording portion
20 communication portion
10 testing unit
50, 58 warning portion
32 accumulation portion
10 analysis portion
20 communication portion
22 family of subject person
24 watch service provider
22 first communication destination
24 second communication destination
10, 20 information acquisition portion
10 testing portion
10, 28, 40, 54 detection portion of air temperature difference
28, 40, 54 temperature sensor
10 testing unit
38, 52 human presence sensor

1. A warning system, comprising:
a living room temperature sensor that measures a room temperature of a living room;
a dressing room temperature sensor that measures a room temperature of a dressing room; and
a warning portion that gives a warning to a subject person when a difference between the room temperature of the living room and the room temperature of the dressing room is not less than a predetermined value.

2. The warning system according to claim 1, further comprising:
an air heating portion that is provided in the dressing room; and
a control portion that, based on the living room temperature sensor and the dressing room temperature sensor, controls the air heating portion to function when the difference between the room temperature of the living room and the room temperature of the dressing room is not less than a predetermined value.

3. The warning system according to claim 1, further comprising:
a human presence sensor,
wherein based on the human presence sensor, the warning portion gives the warning.

4. The warning system according to claim 1, further comprising:
a judgement portion that judges whether the subject person has accepted or disregarded the warning by the warning portion; and
an accumulation portion that records a result of the judgement by the judgement portion and accumulates a behavior history of the subject person.

5. The warning system according to claim 4, further comprising:
a communication portion that communicates to an exterior the result of the judgement by the judgement portion.

6. The warning system according to claim 1, wherein
the warning by the warning portion includes a preliminary warning for creating a warning accepting mentality and a full-fledged warning including warning content information.

7. The warning system according to claim 1, further comprising:
a testing unit that tests a function of the warning portion in any other season than a season in which the warning by the warning portion is required.

8. A warning system, comprising:
a living room temperature sensor that measures a room temperature of a living room;
a dressing room temperature sensor that measures a room temperature of a dressing room;
a warning portion that, based on an air temperature difference between the living room temperature sensor and the dressing room temperature sensor, gives a warning to a subject person;
an accumulation portion that accumulates a behavior history as to whether the subject person has accepted or disregarded the warning by the warning portion; and
an analysis portion that analyzes the behavior history accumulated in the accumulation portion.

9. The warning system according to claim 8, wherein
based on the behavior history, the analysis portion categorizes the subject person under one of a plurality of categories defined in terms of a risk.

10. The warning system according to claim 9, wherein
based on the result of categorizing, the warning portion changes a content of the warning to the subject person.

11. The warning system according to claim 9, further comprising:
a communication portion that communicates to an exterior,
wherein based on the result of categorizing, the communication portion decides whether or not to transmit information from the analysis portion to the exterior.

12. The warning system according to claim 11, wherein
based on the result of categorizing, the communication portion changes a content of communication of the information to be communicated to the exterior.

13. The warning system according to claim 11, wherein
based on the result of categorizing, the communication portion changes a communication destination to which the information from the analysis portion is to be communicated.

14. The warning system according to claim 8, further comprising:
an information acquisition portion that acquires information related to an air temperature change,
wherein based on the information acquisition portion, the warning portion controls the warning.

15. The warning system according to claim 14, wherein
the information related to an air temperature change is at least one of a date and an air temperature forecast.

16. A warning system, comprising:
a living room temperature sensor that measures a room temperature of a living room;
a dressing room temperature sensor that measures a room temperature of a dressing room;
a warning portion that, based on a temperature difference between the living room temperature sensor and the dressing room temperature sensor, gives a warning to a subject person; and
a testing portion that tests a function of the warning portion in any other season than a season in which the warning by the warning portion is required.

17. The warning system according to claim 16, wherein
in the season in which the warning by the warning portion is required, based on the temperature difference between the living room temperature sensor and the dressing room temperature sensor, the warning portion gives the warning, and
in any other season than the season in which the warning by the warning portion is required, based on occurrence of a phenomenon of a reversed temperature difference between the living room temperature sensor and the dressing room temperature sensor, the testing portion tests a function of each of the living room temperature sensor and the dressing room temperature sensor.

18. The warning system according to claim 16, wherein
the warning portion has a human presence sensor that is provided in the dressing room, and
in any other season than the season in which the warning by the warning portion is required, based on whether or not the human presence sensor detects human presence within a predetermined period of time while the subject person is at home, the testing portion tests a function of the human presence sensor.

19. The warning system according to claim 16, wherein
the warning portion has a warning output portion that is provided in the dressing room, and
in any other season than the season in which the warning by the warning portion is required, by applying power to the warning output portion, the testing portion tests a function of the warning output portion.

20. The warning system according to claim 16, wherein
at an early stage upon arrival of the season in which the warning by the warning portion is required, the warning portion calls attention to the warning.
